(19) United States
(12) Patent Application Publication
(10) Pub. No.: US 2021/0040341 A1
(43) Pub. Date: Feb. 11, 2021

(54) INK EJECTION STABILIZER, INK AND TEXTILE PRINTING AGENT CONTAINING THE SAME, AND PRINTED ARTICLE

(71) Applicant: DIC Corporation, Tokyo (JP)

(72) Inventors: Kazunari Kawai, Kitaadachi-gun, Saitama (JP); Ryota Hibino, Kitaadachi-gun, Saitama (JP); Masashi Yamaguchi, Kitaadachi-gun, Saitama (JP)

(73) Assignee: DIC Corporation, Tokyo (JP)

(21) Appl. No.: 16/967,787

(22) PCT Filed: Feb. 7, 2019
(86) PCT No.: PCT/JP2019/004380

§ 371 Date: Aug. 6, 2020

(30) Foreign Application Priority Data
Feb. 19, 2018 (JP) 2018-026943

(51) Int. Cl. C09D 11/322; C09D 11/033; C09D 11/037; C09D 11/102; D06P 5/30; D06P 1/613; D06P 1/52

(52) U.S. Cl. CPC C09D 11/322; C09D 11/033; C09D 11/037; A41D 27/00; D06P 5/30; D06P 1/6136; D06P 1/5285; C09D 11/102

(57) ABSTRACT

The present invention aims to provide an ink ejection stabilizer that can impart high ejection stability, for example, to an ink such as an ink-jet printing ink. The present invention relates to an ink ejection stabilizer including a polymer (A) that has, in a Kratky plot of a scattering profile determined by a small-angle X-ray scattering method using synchrotron radiation, at least one local minimum in the range where a scattering vector q is 0 nm⁻¹ to 2 nm⁻¹. An aqueous solution of the polymer (A) (polymer (A) concentration: 20 mass %) has a parallel light transmittance of 85% or more.

### TECHNICAL FIELD

The present invention relates to an additive that can improve the ejectability through an ejection nozzle of an ink used in producing a printed article, for example, by an ink-jet printing process.

### BACKGROUND ART

Ink-jet printing is employed in the production of various printed articles. In general, ink-jet printing is a method in which an ink is ejected through an ejection nozzle so as to impact on a surface of a recording medium such as a sheet of paper or a textile. As such inks, various ink-jet printing inks have been previously used.

However, as the applicability of ink-jet printing expands, ink-jet printing inks have been required to have the property of being able to form a clear print regardless of the type of recording medium and the ability to form a print having, for example, high rubbing fastness, while conventional inks have sometimes been incapable of satisfying these required properties.

Specifically, for example, the abilities as described above are required in the printing on fiber products such as clothes using the ink-jet printing process.

On fiber products such as clothes, letters, images, and the like may be printed by ink-jet printing in order to provide excellent designs. Known ink-jet printing inks used in such cases include a water-based ink-jet ink that contains water, a pigment, a predetermined binder resin, a water-soluble organic solvent, etc. so that a printed image having high rubbing fastness is formed (see, for example, PTL 1).

However, an ink containing a binder resin as described above has sometimes been insufficient in terms of ink ejection stability; the ink may tend to cause clogging of an ejection nozzle over time, turning of the direction of ejection of the ink over time, or the like. In particular, an ink used for the printing on a textile forming a fiber product tends to contain the binder in a relatively large amount, and there has particularly been a concern that a decrease in ejection stability may be caused when such an ink is used.

### CITATION LIST

### Patent Literature

PTL 1: Japanese Unexamined Patent Application Publication No. 2013-194161

### SUMMARY OF INVENTION

### Technical Problem

It is an object of the present invention to provide an ink ejection stabilizer that can impart high ejection stability, for example, to an ink such as an ink-jet printing ink.

### Solution to Problem

The present invention relates to an ink ejection stabilizer including a polymer (A) that has, in a Kratky plot of a scattering profile determined by a small-angle X-ray scattering method using synchrotron radiation, at least one local minimum in the range where a scattering vector q is 0 nm⁻¹ to 2 nm⁻¹. An aqueous solution of the polymer (A) (polymer (A) concentration: 20 mass %) has a parallel light transmittance of 85% or more.

### Advantageous Effects of Invention

By using the ink ejection stabilizer of the present invention, high ejection stability can be imparted, for example, to an ink such as an ink-jet printing ink.

In addition, by using the ink ejection stabilizer of the present invention, high ejection stability can be imparted, for example, to an ink containing a relatively large amount of binder.

In addition, by using the ink ejection stabilizer of the present invention, high ejection stability can be imparted, for example, to a textile printing agent containing a relatively large amount of binder.

### BRIEF DESCRIPTION OF DRAWINGS

FIG. 1 shows Kratky plots of a polymer (A-1) obtained in Example 1 and a radical copolymer obtained in Comparative Example 3.

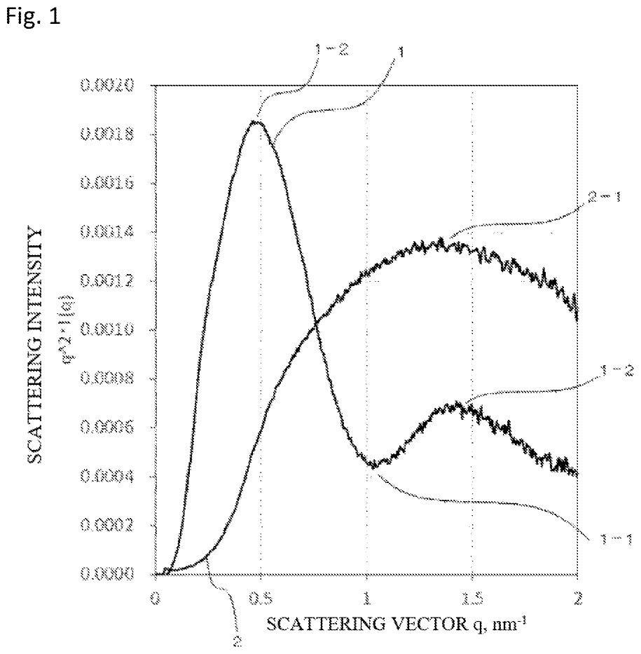

### DESCRIPTION OF EMBODIMENTS

An ink ejection stabilizer of the present invention contains a polymer (A) described below as an essential component and contains other optional components as required.

The polymer (A) has, in a Kratky plot of a scattering profile determined by a small-angle X-ray scattering method using synchrotron radiation, at least one local minimum in the range where a scattering vector q is 0 nm⁻¹ to 2 nm⁻¹, and an aqueous solution containing the polymer (A) and water and in which the concentration of the polymer (A) is 20 mass % has a parallel light transmittance of 85% or more.

As described above, the polymer (A) used in the present invention has, in a Kratky plot of a scattering profile determined by a small-angle X-ray scattering method using synchrotron radiation, at least one local minimum in the range where a scattering vector q is 0 nm⁻¹ to 2 nm⁻¹. This indicates that in a composition containing the polymer (A) and water, the polymer (A) microscopically behaves as particles, while being dissolved in the water macroscopically (visually).

Whether there is the local minimum can be determined based on a Kratky Plot converted from a scattering profile determined by the small-angle X-ray scattering method.

The small-angle X-ray scattering method is a technique for nondestructively analyzing a structure of a substance having a size of about 1 nm to 100 nm. When a substance is irradiated with X-rays, the X-rays are scattered under the influence of electron densities of atoms and molecules constituting the substance. In particular, the small-angle X-ray scattering method refers to a technique for measuring X-ray scattering exhibited in a small-angle region (scattering angle: 0.1°<(2θ)<10°) of X-rays transmitted through a substance. In the present invention, an ultrasmall-angle X-ray scattering method by which X-ray scattering exhibited in a region of 0°<(2θ)≤0.1° as well as the small-angle region is measured may be employed.

To measure the shape and size of the polymer (A) in water, it is suitable to use high-brightness incident X-rays. To achieve an accurate measurement in a realistic period of time, the brightness of the incident X-rays is preferably 10¹⁶ (photons/sec/mm²/mrad²/0.1% bandwidth) or more, more preferably 10¹⁸ or more.

X-rays having a high brightness of 10¹⁶ or more can be used in large high-brightness radiation facilities with light sources, such as SPring-8 in Hyogo prefecture and Photon Factory in Ibaraki prefecture.

For the measurement of a scattering profile using the small-angle X-ray scattering method, the following apparatus is used.

Measurement apparatus: the second hatch of the BL03XU beamline possessed by Frontier Soft-material Beamline consortium in SPring-8 (large high-brightness radiation facility)

Measurement mode: small-angle X-ray scattering (SAXS)

Measurement conditions: X-rays with a wavelength of 0.1 nm; camera length, about 8 m (USAXS) and 2 m (SAXS); beam spot size, 140 μm×80 μm; no attenuators; exposure time, 30 seconds; 2θ=0.01° to 10°.

Analysis software: Fit2D (available from the homepage of European Synchrotron Radiation Facility [http://www.esrf.eu/computing/scientific/FIT2D/]) was used for converting two-dimensional scattering data into a scattering profile.

First, a composition containing the polymer (A) and water, e.g., pure water (the mass ratio of the polymer (A) relative to the total amount of the composition was 0.5 mass %) was provided.

A quartz glass tube containing the composition was placed in the above measurement apparatus, and X-rays were caused to be incident thereon in the above measurement mode under the above measurement conditions to thereby obtain two-dimensional scattering data.

The two-dimensional scattering data were processed using Fit2D to thereby obtain a target scattering profile.

A scattering vector q that makes up the scattering profile is defined by formula (1).

$$\begin{matrix}[ Math . 1 ] & \\ q = \frac{4 π}{λ} sin \frac{θ}{2} & ( 1 )\end{matrix}$$

λ represents a wavelength of X-rays, and 2θ represents a scattering angle. For the wavelength of X-rays and the scattering angle, actually measured values are used.

Next, the scattering profile determined by the above method is converted into a Kratky plot.

The Kratky plot refers to a plot with a scattering vector q represented by the scattering profile on the horizontal axis and the product [I×q²] of a scattering intensity I and the square of the scattering vector q on the vertical axis.

A polymer (A) having, in the Kratky plot, at least one local minimum in the range where the scattering vector q was 0 nm⁻¹ to 2 nm⁻¹ was regarded as microscopically having a particle structure (reference, Synchrotron Radiation, 2006, November Issue, vol. 19, No. 6, p. 345).

The polymer (A) preferably has, in the Kratky plot, one or more local minima in the range where the scattering vector q is 0 nm⁻¹ to 2 nm⁻¹, more preferably has one local minimum to enable the production of a polymer of core-shell type described later and obtain an ink ejection stabilizer that can provide further improved ink ejectability. A region where the scattering vector is small (e.g., 0 nm⁻¹ or more and less than 0.2 nm⁻¹) is readily influenced by the accuracy of measurement, and thus the polymer (A) preferably has one or more local minima in the range where the scattering vector q is 0.2 nm⁻¹ or more and 2 nm⁻¹ or less.

The polymer (A) preferably has, in the Kratky plot, one or more local maxima, more preferably has two or more local maxima, and still more preferably has two local maxima to enable the production of a polymer of core-shell type described later and obtain an ink ejection stabilizer that can provide further improved ink ejectability.

The number of the local maxima present in the range where the scattering vector q is 0 nm⁻¹ to 2 nm⁻¹ is preferably one or more, more preferably two or more, still more preferably two to five, and further more preferably two to enable the production of a polymer of core-shell type described later and obtain an ink ejection stabilizer that can provide further improved ink ejectability.

An aqueous solution of the polymer (A) has a parallel light transmittance of 85% or more. The parallel light transmittance is an indicator of the water solubility of the polymer (A), and the higher the parallel light transmittance is, the more transparent the aqueous solution of the polymer (A) appears by visual observation.

The parallel light transmittance refers to a value determined by the following method.

As a sample used in measuring the parallel light transmittance, an aqueous solution containing the polymer (A) and water is used. The aqueous solution is obtained by adding the polymer (A) to water at, for example, normal temperature to 80° C. and stirring them until the polymer (A) is confirmed to be dissolved in the water by visual observation. An aqueous solution in which a portion or the whole of the polymer (A) is not dissolved in water and a precipitate is visually observed is not judged as having a parallel light transmittance of 85% or more.

For the measurement of the parallel light transmittance, components other than the polymer (A) and water are preferably not contained in the sample. Thus, when the sample is prepared, care should be taken not to be contaminated with components other than the polymer (A) and water.

The amount of components other than the polymer (A) and water relative to the total amount of the aqueous solution is preferably 1 mass % or less, particularly preferably 0 mass % to 0.5 mass %.

The sample contains the polymer (A) in an amount of 20 mass % relative to the total amount of the aqueous solution.

To accurately measure the parallel light transmittance, the water is preferably ion-exchange water, pure water, or ultrapure water, which contains few impurities.

For the measurement of the parallel light transmittance of the sample, an integrating-sphere electrophotometric turbidimeter is used. Although any measurement apparatus may be used, values measured with an NDM2000 (D65) manufactured by Nippon Denshoku Industries Co., Ltd. are shown in the present invention. The measurement principle of the NDM2000 is in accordance with JIS K7136. A sample prepared by the above method is injected into a prismatic cell for liquid (10 mm×36 mm×55 mm) such that no bubbles are formed, and the parallel light transmittance is measured at an optical path of 10 mm.

The polymer (A) preferably has a parallel light transmittance of 85% or more, and more preferably has a parallel light transmittance of 90% or more to enable the production of a polymer (A) having the desired local minimum and transmittance and obtain an ink ejection stabilizer that can provide further improved ink ejectability.

The polymer (A) having such a parallel light transmittance can be visually judged as being dissolved in water. The polymer (A) is preferably soluble in 100 g of water at 25° C.

On the other hand, since the polymer (A) has the desired local minimum, the polymer (A) microscopically exhibits particulate behavior.

In the present invention, a polymer that exhibits a specific behavior as described above is selected from a large number of conventionally known polymers, and when the polymer is used in an additive for an ink-jet printing ink, the ejectability of the ink can be significantly improved.

The polymer (A) is preferably, for example, a polymer having structures with different polarities. More specifically, the polymer (A) is preferably a polymer having a structure in which a hydrophilic structure and a hydrophobic structure are localized.

The hydrophilic structure may be, for example, a structure having a hydrophilic group such as an anionic group, a cationic group, or a nonionic group. To microscopically exhibit particulate behavior, a structure having a nonionic group is preferred.

The nonionic group preferably has, for example, an oxyethylene structure.

In the polymer (A), the ratio of the oxyethylene structure relative to the total amount of the polymer (A) is preferably 10 mol % or more, more preferably 13 mol % to 30 mol %.

The polymer (A) may have an oxyalkylene structure such as an oxypropylene structure other than the oxyethylene structure, but to enable the production of a polymer (A) having the desired local minimum and transmittance and obtain an ink ejection stabilizer that can provide further improved ink ejectability, the content of the oxypropylene structure or the like is preferably as small as possible.

In the polymer (A), the mass ratio of the oxyethylene structure relative to the total amount of the oxyalkylene structure is preferably 90 mass % to 100 mass %, more preferably 95 mass % to 100 mass %.

More specifically, the polymer (A) may be a vinyl polymer such as an acrylic polymer, a urethane resin, or a polyester resin. In particular, the polymer (A) is preferably a vinyl polymer because the flexibility of design for microscopically exhibiting particulate behavior is high.

Of the vinyl polymers, the vinyl polymer having the nonionic group is more preferably a polymer having, more specifically, a polyoxyethylene chain as a side chain of a main-chain vinyl polymer, to enable the production of a polymer (A) having the desired local minimum and transmittance and obtain an ink ejection stabilizer that can provide further improved ink ejectability.

In the vinyl polymer having a polyoxyethylene structure as a side chain of a main-chain vinyl polymer, the ratio of oxyethylene units relative to the total amount of monomer components constituting the vinyl polymer is preferably 10 mol % or more, preferably 13 mol % or more, and more preferably 23 mol % to 45 mol % to enable the production of a polymer (A) having the desired local minimum and transmittance and obtain an ink ejection stabilizer that can provide further improved ink ejectability.

The vinyl polymer is preferably the vinyl polymer of core-shell type. The vinyl polymer of core-shell type is preferably, for example, a vinyl polymer having the above-described oxyethylene structure. Specifically, the vinyl polymer having the oxyethylene structure preferably has a core portion formed of a main-chain vinyl polymer and a shell portion formed of the polyoxyethylene structure, which is a side chain of the vinyl polymer, to enable the production of a polymer (A) having the desired local minimum and transmittance and obtain an ink ejection stabilizer that can provide further improved ink ejectability.

The vinyl polymers including the vinyl polymer having the oxyethylene structure can be produced, for example, by polymerizing a monomer component.

For example, when an acrylic polymer having the oxyethylene structure is produced, the monomer component may be polyoxyethylene glycol (meth)acrylate or methoxypolyethylene glycol (meth)acrylate. Examples of specific trade names include NK ester M-90G, NK ester M-130G, and NK ester M-230G manufactured by Shin-Nakamura Chemical Co., Ltd., LIGHT ACRYLATE 130A manufactured by Kyoeisha Chemical Co., Ltd., and BLEMMER PME-200, PME-400, PME-1000, PME-4000, and AME-400 manufactured by NOF Corporation. Of these, monomer components in which the number of repeating units of the oxyethylene structure is 15 or more and 50 or less, such as NK ester M-230G manufactured by Shin-Nakamura Chemical Co., Ltd. and BLEMMER PME-1000 manufactured by NOF Corporation, are more preferred to provide microscopic particulate behavior as well as to provide hydrophilicity.

To introduce the hydrophobic structure into the polymer (A), the monomer may be, for example, an aromatic vinyl monomer such as styrene or a vinyl monomer such as alkyl (meth)acrylate.

The polymer (A) may have an anionic group. The polymer (A) preferably has both the nonionic group and the anionic group.

When the polymer (A) has the anionic group, in addition to monobasic acids such as (meth)acrylic acid, for example, dibasic acids such as maleic acid and itaconic acid can be used as the monomer.

To set the parallel light transmittance to 85% or more, the polymer (A) preferably has the anionic group in an amount of 3 to 10 mol % relative to the whole polymer (A).

To obtain an ink ejection stabilizer that is water-soluble and can provide further improved ink ejectability, the polymer (A) obtained by the above method preferably has a weight average molecular weight of 30,000 or less, more preferably in the range of 5,000 to 20,000.

The polymer (A) can be used primarily for an additive (ink ejection stabilizer) for imparting ejection stability to an ink.

The ink ejection stabilizer contains the polymer (A) preferably in an amount ranging from 0.1 mass % to 40 mass % relative to the total amount of the ink ejection stabilizer, and more preferably in an amount ranging from 10 mass % to 30 mass % to achieve a balance between the ejectability-improving effect and other physical properties of the ink, such as viscosity and surface tension.

The ink ejection stabilizer may optionally contain other components in addition to the polymer (A).

The ink ejection stabilizer of the present invention can provide various inks such as ink-jet printing inks with ejection stability at a level where ejection nozzles are less easily clogged over time and the direction of ejection of the inks will not change over time.

The ink ejection stabilizer of the present invention can be used for both a water-based ink and a solvent ink, and is preferably used for a water-based ink.

The ink ejection stabilizer is preferably used in an amount ranging from 0.1 mass % to 10 mass % relative to the total amount of the water-based ink, and particularly preferably used in an amount ranging from 1.0 mass % to 5.0 mass % to achieve a balance between an even higher ejectability-improving effect and other physical properties of the ink, such as viscosity and surface tension.

Examples of the water-based ink include pigment inks and dye inks. The water-based ink containing a pigment may be, for example, a water-based ink containing a pigment, a resin for pigment dispersion, and an aqueous medium and further containing the ink ejection stabilizer.

To maintain good storage stability of the water-based ink, the water-based ink may, for example, contain, relative to 100 parts by mass of the water-based ink, the pigment preferably in an amount of 1 part by mass to 20 parts by mass, the resin for pigment dispersion preferably in an amount of 0.1 parts by mass to 2 parts by mass, and the ink ejection stabilizer preferably in an amount in the above-described range, with the remainder being a solvent such as water or a water-soluble organic solvent.

The pigment may be an organic pigment or an inorganic pigment, and may be an untreated pigment or a treated pigment.

Examples of the inorganic pigment include iron oxide and carbon black.

Examples of the organic pigment include azo pigments (including azo lake, insoluble azo pigments, condensed azo pigments, and chelated azo pigments), polycyclic pigments (e.g., phthalocyanine pigments, perylene pigments, perinone pigments, anthraquinone pigments, quinacridone pigments, dioxazine pigments, thioindigo pigments, isoindolinone pigments, and quinophthalone pigments), dye chelates (e.g., basic dye chelates and acidic dye chelates), nitro pigments, nitroso pigments, and aniline black.

To provide hydrophilicity, the resin for pigment dispersion may contain a carboxy group, a sulfonic group, or a phosphate group.

Examples of compounds having the anionic group include polyvinyl resins having the anionic group, polyester resins having the anionic group, amino resins having the anionic group, acrylic copolymers having the anionic group, epoxy resins having the anionic group, polyurethane resins having the anionic group, polyether resins having the anionic group, polyamide resins having the anionic group, unsaturated polyester resins having the anionic group, phenol resins having the anionic group, silicone resins having the anionic group, and fluoropolymer compounds having the anionic group. In particular, styrene-(meth)acrylic acid copolymers, styrene-(meth)acrylate-(meth)acrylic acid copolymers, and the like are preferably used.

Examples of the water-soluble organic solvent include glycols such as ethylene glycol, diethylene glycol, triethylene glycol, tetraethylene glycol, propylene glycol, polyethylene glycol, and polypropylene glycol; diols such as butanediol, pentanediol, hexanediol, and their homologues; glycol esters such as propylene glycol laurate; glycol ethers such as ethers including diethylene glycol monoethyl ether, diethylene glycol monobutyl ether, and diethylene glycol monohexyl ether, cellosolves including propylene glycol ether, dipropylene glycol ether, and triethylene glycol ether, polyethylene adducts of glycerol, polyoxypropylene adducts of glycerol, and polyoxypropylene and polyoxyethylene adducts of glycerol; alcohols such as methanol, ethanol, isopropyl alcohol, 1-propanol, 2-propanol, 1-butanol, 2-butanol, butyl alcohol, pentyl alcohol, and their homologues; sulfolane; lactones such as γ-butyrolactone; lactams such as pyrrolidone, N-methyl-2-pyrrolidone, and γ-butyrolactone; and glycerol and derivatives thereof. These may be used alone or in combination of two or more.

The water-based ink may be a water-based ink further containing a binder (B) for the purpose of improvement in rubbing fastness of prints or improvement in print density.

The binder (B) is preferably used in an amount ranging from 0.1 mass % to 15 mass % relative to the total amount of the water-based ink, and more preferably used in an amount ranging from 0.5 mass % to 10 mass % for further improvement, for example, in rubbing fastness of prints or print density.

The water-based ink containing the binder (B) in the above-described range typically tends to have an increased viscosity and thus may undergo a decrease in ejection stability over time. Particularly when it is intended to improve the rubbing fastness of prints on textiles and the like, an ink containing the binder (B) is a relatively large amount (about 6 mass % to 10 mass %) may be used, and such an ink may readily undergo a decrease in ejection stability as compared to other inks.

However, an ink containing the ink ejection stabilizer of the present invention, if containing the binder (B) in a relatively large amount, can maintain the high ejection stability of the ink and can also produce effects such as improvements in rubbing fastness of prints and print density due to the use of the binder (B).

Examples of the binder (B) include natural proteins such as glue, gelatin, casein, albumin, gum arabic, and fish glue; and alginic acid, methylcellulose, carboxymethylcellulose, polyethylene oxide, hydroxyethylcellulose, polyvinyl alcohol, polyacrylamide, aromatic amide, polyacrylic acid, polyvinyl ether, polyvinylpyrrolidone, polyurethane, polyester, acrylic acid-acrylate copolymers, styrene-maleic acid resins, and styrene-acrylic acid resins. When it is intended to improve the rubbing fastness of prints on textiles and the like, the binder (B) is preferably polyurethane to provide good rubbing fastness even when the ink is printed on various types of textile and to achieve both good rubbing fastness and prevention of an excessive increase in ink viscosity.

The ink containing the ink ejection stabilizer of the present invention is preferably used primarily for printing using an ink-jet printing process.

Examples of the ink-jet printing process include a thermal ink-jet printing process and a piezoelectric ink-jet printing process.

Many high value-added inks of the related art that can form prints with high rubbing fastness and a high density are developed for the piezoelectric ink-jet printing process, and thus if such an ink is simply used for the thermal ink-jet printing process, the ink cannot be ejected in many cases. This is probably due to the use of the binder (B) for adding high value to the ink.

In industry, there has recently been a demand for the development of an ink from which a print having rubbing fastness and a high print density can be formed by the thermal ink-jet printing process. In particular, in the production of fiber products such as clothes and curtains, it is required to form a printed image having rubbing fastness and a high print density on a fiber base material made of a textile such as cotton by the thermal ink-jet printing process.

The ink ejection stabilizer of the present invention, when added to a piezoelectric ink-jet printing ink of the related art or an ink containing a binder (B), which can hardly be ejected by the thermal ink-jet printing process, enables the ink to be ejected by the thermal ink-jet printing process.

The ink containing the ink ejection stabilizer of the present invention can primarily be used as a textile printing agent used for printing on a fiber product such as a textile.

Examples of recording media on which a print can be formed using the ink containing the ink ejection stabilizer of the present invention include the above-described textile, absorbent recording media such as plain paper (PPC paper), recording media having ink absorbing layers, non-absorbent recording media without ink absorbency, and poorly-absorbent recording media with low ink absorbency. In particular, for example, the textile and plain paper (PPC paper) can be used.

Examples of printed articles produced by forming a print on a recording medium using the ink containing the ink ejection stabilizer of the present invention include clothes such as T-shirts.

### EXAMPLES

The present invention will now be described in more detail with reference to examples.

### Example 1

In a 5-liter flask equipped with a mechanical stirrer, a thermocouple, a nitrogen inlet, two dropping funnels, and a reflux tube, 2,250 g of butyl acetate, 143.6 g of styrene, 300.2 g of NK ester AM-230G (methoxypolyethylene glycol methacrylate manufactured by Shin-Nakamura Chemical Co., Ltd.), and 6.3 g of acrylic acid were placed and heated to 95° C. After reaching 95° C., 8.0 g of benzoyl peroxide was added to initiate a reaction.

After one hour from the initiation of the reaction, monomer feed, i.e., dropwise addition of a mixture of 335.0 g of styrene, 700.4 g of NK ester AM-230G (methoxypolyethylene glycol methacrylate manufactured by Shin-Nakamura Chemical Co., Ltd.), and 14.7 g of acrylic acid into the flask was started. In the dropwise addition, the monomer feed was performed evenly over 60 minutes while maintaining the temperature inside the flask at 95° C.

After the dropwise addition was completed, the substances in the flask were refluxed for 300 minutes.

Thereafter, the butyl acetate in the flask was removed by distillation to thereby obtain a viscous liquid polymer (A-1) (weight average molecular weight: 10,000) having a polyoxyethylene structure as a side chain of a main-chain vinyl polymer. The polymer (A-1) and an aqueous potassium hydroxide solution were mixed together to neutralize all carboxyl groups of the polymer (A-1), thereby obtaining an ink ejection stabilizer.

The ratio of an oxyethylene structure relative to the whole polymer (A-1) was 14.5 mol %, and the mass ratio of the oxyethylene structure relative to the total amount of an oxyalkylene structure of the polymer (A-1) was 100 mass %.

### Example 2

In a 5-liter flask equipped with a mechanical stirrer, a thermocouple, a nitrogen inlet, two dropping funnels, and a reflux tube, 2,250 g of butyl acetate, 143.6 g of styrene, 300.2 g of NK ester AM-90G (methoxypolyethylene glycol methacrylate manufactured by Shin-Nakamura Chemical Co., Ltd.), and 6.3 g of acrylic acid were placed and heated to 95° C. After reaching 95° C., 8.0 g of benzoyl peroxide was added to initiate a reaction.

After one hour from the initiation of the reaction, monomer feed, i.e., dropwise addition of a mixture of 335.0 g of styrene, 700.4 g of NK ester AM-90G (methoxypolyethylene glycol methacrylate manufactured by Shin-Nakamura Chemical Co., Ltd.), and 14.7 g of acrylic acid into the flask was started. In the dropwise addition, the monomer feed was performed evenly over 60 minutes while maintaining the temperature inside the flask at 95° C.

After the dropwise addition was completed, the substances in the flask were refluxed for 300 minutes.

Thereafter, the butyl acetate in the flask was removed by distillation to thereby obtain a viscous liquid polymer (A-2) (weight average molecular weight: 10,000) having a polyoxyethylene structure as a side chain of a main-chain vinyl polymer. The polymer (A-2) and an aqueous potassium hydroxide solution were mixed together to neutralize all carboxyl groups of the polymer (A-2), thereby obtaining an ink ejection stabilizer.

The ratio of an oxyethylene structure relative to the whole polymer (A-2) was 24.7 mol %, and the mass ratio of the oxyethylene structure relative to the total amount of an oxyalkylene structure of the polymer (A-2) was 100 mass %.

### Example 3

In a 5-liter flask equipped with a mechanical stirrer, a thermocouple, a nitrogen inlet, two dropping funnels, and a reflux tube, 2,250 g of butyl acetate, 143.6 g of styrene, 300.2 g of NK ester AM-230G (methoxypolyethylene glycol methacrylate manufactured by Shin-Nakamura Chemical Co., Ltd.), and 6.3 g of acrylic acid were placed and heated to 95° C. After reaching 95° C., 15.0 g of benzoyl peroxide was added to initiate a reaction.

After one hour from the initiation of the reaction, monomer feed, i.e., dropwise addition of a mixture of 335.0 g of styrene, 700.4 g of NK ester AM-230G (methoxypolyethylene glycol methacrylate manufactured by Shin-Nakamura Chemical Co., Ltd.), and 14.7 g of acrylic acid into the flask was started. In the dropwise addition, the monomer feed was performed evenly over 60 minutes while maintaining the temperature inside the flask at 95° C.

After the dropwise addition was completed, the substances in the flask were refluxed for 300 minutes.

Thereafter, the butyl acetate in the flask was removed by distillation to thereby obtain a viscous liquid polymer (A-3) (weight average molecular weight: 5,000) having a polyoxyethylene structure as a side chain of a main-chain vinyl polymer. The polymer (A-3) and an aqueous potassium hydroxide solution were mixed together to neutralize all carboxyl groups of the polymer (A-3), thereby obtaining an ink ejection stabilizer.

The ratio of an oxyethylene structure relative to the whole polymer (A-3) was 14.5 mol %, and the mass ratio of the oxyethylene structure relative to the total amount of an oxyalkylene structure of the polymer (A-3) was 100 mass %.

### Comparative Example 1

In a 5-liter flask equipped with a mechanical stirrer, a thermocouple, a nitrogen inlet, two dropping funnels, and a reflux tube, 2,250 g of butyl acetate, 143.6 g of styrene, 300.2 g EMF-063 (polyethylene polypropylene glycol methacrylate manufactured by HANNONG CHEMICALS INC.), and 6.3 g of acrylic acid were placed and heated to 95° C. After reaching 95° C., 8.0 g of benzoyl peroxide was added to initiate a reaction.

After one hour from the initiation of the reaction, monomer feed, i.e., dropwise addition of a mixture of 335.0 g of styrene, 700.4 g of EMF-063 (polyethylene polypropylene glycol methacrylate manufactured by HANNONG CHEMICALS INC.), and 14.7 g of acrylic acid into the flask was started. In the dropwise addition, the monomer feed was performed evenly over 60 minutes while maintaining the temperature inside the flask at 95° C.

After the dropwise addition was completed, the substances in the flask were refluxed for 300 minutes.

Thereafter, the butyl acetate in the flask was removed by distillation to thereby obtain a viscous liquid polymer (A-4) (weight average molecular weight: 10,000) having a polyoxyethylene structure as a side chain of a main-chain vinyl polymer. The polymer (A-4) and an aqueous potassium hydroxide solution were mixed together to neutralize all carboxyl groups of the polymer (A-4), thereby obtaining an ink ejection stabilizer.

The ratios of an oxyethylene structure and an oxypropylene structure relative to the whole polymer (A-4) were 16.4 mol % and 8.2 mol %, respectively, and the mass ratio of the oxyethylene structure relative to the total amount of an oxyalkylene structure of the polymer (A-4) was 66.7 mass %.

### Comparative Example 2

In a 5-liter flask equipped with a mechanical stirrer, a thermocouple, a nitrogen inlet, two dropping funnels, and a reflux tube, 2,250 g of butyl acetate, 143.6 g of styrene, 300.2 g of NK ester AM-230G (methoxypolyethylene glycol methacrylate manufactured by Shin-Nakamura Chemical Co., Ltd.), and 6.3 g of acrylic acid were placed and heated to 95° C. After reaching 95° C., 3.0 g of benzoyl peroxide was added to initiate a reaction.

After one hour from the initiation of the reaction, monomer feed, i.e., dropwise addition of a mixture of 335.0 g of styrene, 700.4 g of NK ester AM-230G (methoxypolyethylene glycol methacrylate manufactured by Shin-Nakamura Chemical Co., Ltd.), and 14.7 g of acrylic acid into the flask was started. In the dropwise addition, the monomer feed was performed evenly over 60 minutes while maintaining the temperature inside the flask at 95° C.

After the dropwise addition was completed, the substances in the flask were refluxed for 300 minutes.

Thereafter, the butyl acetate in the flask was removed by distillation to thereby obtain a viscous liquid polymer (A-5) (weight average molecular weight: 50,000) having a polyoxyethylene structure as a side chain of a main-chain vinyl polymer. The polymer (A-5) and an aqueous potassium hydroxide solution were mixed together to neutralize all carboxyl groups of the polymer (A-5), thereby obtaining an ink ejection stabilizer.

The ratio of an oxyethylene structure relative to the whole polymer (A-5) was 14.5 mol %, and the mass ratio of the oxyethylene structure relative to the total amount of an oxyalkylene structure of the polymer (A-5) was 100 mass %.

### Comparative Example 3

Fifty-six grams of styrene, 19.09 g of acrylic acid, 24.81 g of methacrylic acid, and 0.1 g of n-butyl acrylate were subjected to radical polymerization, and drying or the like was performed to obtain a powdery polymer (weight average molecular weight: 6,300, acid value: 280 mgKOH/g, glass transition point: 126° C.)

Next, an aqueous solution obtained by adding 5 g of the powdery polymer to a mixture of 17.28 g of pure water and 4.12 g of a 34% aqueous potassium hydroxide solution and stirring the resulting mixture was used in place of the ink ejection stabilizer of the present invention.

### Comparative Example 4

A solution obtained by diluting a HYDRAN WLS-213 (urethane dispersion manufactured by DIC Corporation, solids content: 35 mass %) with pure water to a solids content of 20 mass % was used in place of the ink ejection stabilizer of the present invention.

[Method for Obtaining Kratky Plot of Scattering Profile Determined by Small-Angle X-Ray Scattering Method Using Synchrotron Radiation]

As a measurement apparatus, the second hatch of the BL03XU beamline possessed by Frontier Soft-material Beamline consortium in SPring-8 (large high-brightness radiation facility) was used, and the measurement mode used was small-angle X-ray scattering (SAXS).

As a measurement sample, a composition obtained by mixing each of the polymers obtained in Examples and Comparative Examples and pure water and containing each polymer in an amount of 0.5 mass % was used.

The measurement conditions were as follows: X-rays with a wavelength of 0.1 nm; camera length, about 8 m (USAXS) and 2 m (SAXS); beam spot size, 140 μm×80 μm; no attenuators; exposure time, 30 seconds; 2θ=0.01° to 10°. Fit2D analysis software (available from the homepage of European Synchrotron Radiation Facility [http://www.esrf.eu/computing/scientific/FIT2D/]) was used for converting two-dimensional scattering data into a scattering profile.

[Method for Measuring Parallel Light Transmittance of Polymer Solution]

As a sample used in measuring a parallel light transmittance, an aqueous solution containing each of the polymers and pure water was used. Pure water at normal temperature and each of the polymers obtained in Examples and Comparative Examples were mixed and stirred to obtain an aqueous polymer solution in which the concentration of the polymer was 20 mass %. An aqueous polymer solution in which a portion or the whole of the polymer was not dissolved in pure water and a precipitate was visually observed was judged as not having a parallel light transmittance of 85% or more.

For the measurement of the parallel light transmittance of the sample, an NDM2000 (D65) manufactured by Nippon Denshoku Industries Co., Ltd. was used. The sample was injected into a prismatic cell for liquid (10 mm×36 mm×55 mm) such that no bubbles were formed, and the parallel light transmittance was measured at an optical path of 10 mm.

Table 1 shows the numbers of local maxima and local minima based on a Kratky plot of a scattering profile of a radical polymer contained in each ink ejection stabilizer, the scattering profile being determined by a small-angle X-ray scattering method, and the evaluation results of the parallel light transmittance. In the measurement of the parallel light transmittance, samples in which a portion or the whole of the radical polymer was not dissolved in water and a precipitate was visually observed were evaluated as “insoluble”.

TABLE 1

| | Number | Number | Parallel light |
|---|---|---|---|
| | of local | of local | transmittance |
| | minima | maxima | (%) |
| Example 1 | 1 | 2 | 96.3 |
| Example 2 | 1 | 2 | 95.1 |
| Example 3 | 1 | 2 | 97.8 |
| Comparative | 1 | 2 | insoluble |
| Example 1 | | | |
| Comparative | 1 | 2 | 84.2 |
| Example 2 | | | |
| Comparative | 0 | 1 | insoluble |
| Example 3 | | | |
| Comparative | 1 | 2 | 71.6 |
| Example 4 | | | |

### Example 4

### Production of Water-Based Pigment Dispersion

Five parts by mass of a resin for pigment dispersion (radical polymer of styrene/acrylic acid/methacrylic acid/n-butyl acrylate=74.00/11.26/14.64/0.10 (mass ratio), acid value: 175, weight average molecular weight: 11,000), 48.75 parts by mass of “FASTOGEN Super Magenta RY (manufactured by DIC Corporation)” as a quinacridone pigment, and 1.25 parts by mass of a phthalimidomethyl adduct as a quinacridone pigment derivative were put into a planetary mixer (trade name: Chemical Mixer ACM04LVTJ-B manufactured by AICOHSHA MFG. CO., LTD.), and a jacket was heated. After the temperature of the contents reached 80° C., kneading was performed at a rotation speed of 80 rpm and a revolution speed of 25 rpm. After 5 minutes from the start of the kneading, 50 parts by mass of triethylene glycol and 0.75 parts by mass of a 34 mass % aqueous potassium hydroxide solution were added.

The kneading was continued until 120 minutes had passed since the planetary mixer exhibited a maximum current value to obtain a kneaded mixture. The mass ratio (R/P) of the resin for pigment dispersion relative to the total mass of the quinacridone pigment and the quinacridone pigment derivative contained in the kneaded mixture was 0.100.

The kneaded mixture in an amount of 80 parts by mass was taken out of the jacket, cut into 1-cm cubes, and then placed in a commercially available blender. Thereto, 80 parts by mass of pure water were added, and the blender was run for 10 minutes for mixture and dilution to disperse the kneaded mixture in the pure water.

Pure water and triethylene glycol were further added to obtain a water-based pigment dispersion having a quinacridone pigment concentration of 14.5 mass %. The concentration of triethylene glycol relative to the quinacridone pigment was 100 mass %.

With 33.33 parts by mass of a diluted solution obtained by diluting the water-based pigment dispersion with pure water to a pigment concentration of 12 mass %, 2 parts by mass of the ink ejection stabilizer obtained in Example 1, 8 parts by mass of 2-pyrrolidinone, 8 parts by mass of triethylene glycol mono-n-butyl ether, 3 parts by mass of purified glycerol, 0.5 parts by mass of SURFYNOL 440 (manufactured by Air Products), 17.14 parts by mass of WLS-213 (urethane dispersion manufactured by DIC Corporation, solids content: 35 mass %), and 30.03 parts by mass of pure water were mixed to thereby obtain a water-based ink for ink-jet recording having a pigment concentration of 4 mass %.

### Example 5

A water-based pigment dispersion and a water-based ink for ink-jet recording were obtained in the same manner as in Example 4 except that the ink ejection stabilizer obtained in Example 2 was used in place of the ink ejection stabilizer obtained in Example 1.

### Example 6

A water-based pigment dispersion and a water-based ink for ink-jet recording were obtained in the same manner as in Example 4 except that the ink ejection stabilizer obtained in Example 3 was used in place of the ink ejection stabilizer obtained in Example 1.

### Comparative Example 5

A water-based pigment dispersion and a water-based ink for ink-jet recording were obtained in the same manner as in Example 4 except that water was used in place of the ink ejection stabilizer obtained in Example 1.

### Comparative Example 6

A water-based pigment dispersion and a water-based ink for ink-jet recording were obtained in the same manner as in Example 4 except that the ink ejection stabilizer obtained in Comparative Example 1 was used in place of the ink ejection stabilizer obtained in Example 1.

### Comparative Example 7

A water-based pigment dispersion and a water-based ink for ink-jet recording were obtained in the same manner as in Example 4 except that the ink ejection stabilizer obtained in Comparative Example 2 was used in place of the ink ejection stabilizer obtained in Example 1.

### Comparative Example 8

A water-based pigment dispersion and a water-based ink for ink-jet recording were obtained in the same manner as in Example 4 except that the ink ejection stabilizer obtained in Comparative Example 3 was used in place of the ink ejection stabilizer obtained in Example 1.

### Comparative Example 9

A water-based pigment dispersion and a water-based ink for ink-jet recording were obtained in the same manner as in Example 4 except that the ink ejection stabilizer obtained in Comparative Example 4 was used in place of the ink ejection stabilizer obtained in Example 1.

(Evaluation of Water-Based Ink for Ink-Jet Recording)

(Method of Measuring Viscosity)

The viscosity of a water-based ink for ink-jet recording at 25° C. was measured using a Viscometer TV-20 (manufactured by Toki Sangyo Co., Ltd.).

(Evaluation of Ejection Stability)

In a constant temperature and humidity room (room temperature 25° C., humidity 50%), the water-based ink for ink-jet recording was loaded into an ink-jet recording apparatus (ENVY4500 manufactured by Hewlett-Packard Company) including a thermal ink-jet nozzle, and continuous printing was performed on 20 sheets of PPC paper.

G: Continuous printing was successfully carried out on 20 sheets without clogging of the ink ejection nozzle.

M: Although continuous printing was successfully carried out on 10 sheets without clogging of the ink ejection nozzle, clogging of the ink ejection nozzle occurred after that, and continuous printing could not be carried out on 20 sheets.

N: Clogging of the ink ejection nozzle occurred, and continuous printing could not be carried out on 10 sheets.

TABLE 2

| | Viscosity | Ejection |
|---|---|---|
| | (mPa · s) | stability |
| Example 4 | 5.0 | G |
| Example 5 | 4.9 | G |
| Example 6 | 4.6 | G |
| Comparative | 4.7 | N |
| Example 5 | | |
| Comparative | 4.7 | M |
| Example 6 | | |
| Comparative | 5.2 | M |
| Example 7 | | |
| Comparative | 5.3 | N |
| Example 8 | | |
| Comparative | 5.0 | N |
| Example 9 | | |

By using the ink ejection stabilizer of the present invention, high ejection stability was successfully imparted, for example, to an ink such as an ink-jet printing ink.

In addition, by using the ink ejection stabilizer of the present invention, high ejection stability was successfully imparted, for example, to an ink containing a relatively large amount of binder.

In addition, by using the ink ejection stabilizer of the present invention, high ejection stability was successfully imparted, for example, to a textile printing agent containing a relatively large amount of binder.

### REFERENCE SIGNS LIST

1. Kratky plot of polymer (A-1) obtained in Example 1

1-1. Local minimum in Kratky plot of polymer (A-1) obtained in Example 1

1-2. Local maximum in Kratky plot of polymer (A-1) obtained in Example 1

2. Kratky plot of polymer obtained in Comparative Example 3

2-1. Local maximum in Kratky plot of polymer obtained in Comparative Example 3

1. An ink ejection stabilizer comprising a polymer (A) that has, in a Kratky plot of a scattering profile determined by a small-angle X-ray scattering method using synchrotron radiation, at least one local minimum in a range where a scattering vector q is 0 nm⁻¹ to 2 nm⁻¹, wherein an aqueous solution of the polymer (A) (polymer (A) concentration: 20 mass %) has a parallel light transmittance of 85% or more.

2. The ink ejection stabilizer according to claim 1, wherein the polymer (A) has, in the Kratky plot, two local maxima in the range where the scattering vector q is 0 nm⁻¹ to 2 nm⁻¹.

3. The ink ejection stabilizer according to claim 1, wherein the polymer (A) has an oxyethylene structure in an amount of 10 mol % or more relative to the whole polymer (A).

4. The ink ejection stabilizer according to claim 1, wherein the polymer (A) has an oxyalkylene structure, and a mass ratio of the oxyethylene structure relative to a total amount of the oxyalkylene structure is 90 mass % to 100 mass %.

5. The ink ejection stabilizer according to claim 1, wherein the polymer (A) has a polyoxyethylene structure as a side chain of a main-chain vinyl polymer.

6. The ink ejection stabilizer according to claim 1, wherein the polymer (A) has a weight average molecular weight of 30,000 or less.

7. An ink comprising a pigment, a resin for pigment dispersion, an aqueous medium, and the ink ejection stabilizer according to claim 1.

8. The ink according to claim 7, wherein the ink ejection stabilizer is contained in an amount ranging from 0.1 mass % to 10 mass % relative to a total amount of the ink.

9. The ink according to claim 7, further comprising a binder (B).

10. The ink according to claim 9, wherein the binder (B) is polyurethane.

11. The ink according to claim 7, wherein the binder (B) is present in an amount ranging from 0.1 mass % to 15 mass % relative to the total amount of the ink.

12. The ink according to claim 7, wherein the ink is used for printing using an ink-jet printing process.

13. The ink according to claim 12, wherein the ink-jet printing process is a thermal ink-jet printing process.

14. A textile printing agent comprising the ink according to claim 7.

15. A printed article comprising a textile and the textile printing agent according to claim 14 applied onto the textile.
